(19) United States
(12) Patent Application Publication
(10) Pub. No.: US 2016/0252215 A1
(43) Pub. Date: Sep. 1, 2016

(54) METHOD AND DEVICE FOR REGULATING THE PRESSURE IN A LIQUEFIED NATURAL GAS VESSEL

(71) Applicant: LINDE AKTIENGESELLSCHAFT, München (DE)

(72) Inventors: Christoph Windmeier, Geretsried (DE); Rainer Hoffmann, Unterhaching (DE); Dirk Rammes, Hohenschäftlarn (DE)

(21) Appl. No.: 15/032,906

(22) PCT Filed: Sep. 30, 2014
(86) PCT No.: PCT/EP2014/002658

§ 371 Date: Apr. 28, 2016

(30) Foreign Application Priority Data
Oct. 31, 2013 (DE) 10 2013 018 341.3

(51) Int. Cl. F17C 13/02; F17C 5/02

(52) U.S. Cl. CPC F17C 13/025; F17C 13/026; F17C 5/02; F17C 2250/03

(57) ABSTRACT

A method is provided for regulating the pressure in a first vessel, having a substance mixture which is present in liquid and gaseous phases and which has a first component and a second component, wherein, in the method, the temperature of the substance mixture is set such that the pressure in the first vessel lies below a predefinable value and, at the set temperature and the pressure in the first vessel, the substance mixture is present only in the liquid and gaseous phases.

The invention relates to a method for regulating the pressure or temperature in a vessel according to the preamble of claim 1, and to a refrigeration arrangement, in particular for performing the method according to the invention, according to claim 11.

LNG (Liquefied Natural Gas) is a cryogenic liquid mainly composed of methane, but also of higher hydrocarbons, such as for example ethane, propane and butane. Furthermore, LNG may also contain small quantities of nitrogen, wherein the proportion thereof varies depending on the quality and purity of the LNG. The gas phase arising during the storage, transportation and handling of cryogenicaiiy liquefied gases, in particular through ingress of heat or pressure reduction, is known as boil-off gas.

The occurrence of boil-off gas results in a rise in pressure In such a vessel, which has to be compensated. According to the prior art, LNG boil-off gas is often either fed into the gas grid, used to generate power or heat, or externally recondensed and returned to the liquefied natural gas vessel. Since at least in Germany LNG boil-off gas must not under normal operation be output to the atmosphere or flared off, external LNG supercoolers in the form of forced-flow heat exchangers are used for example, these reducing the pressure in the vessel. This technology is comparatively complex and costly.

A refrigeration unit based on liquid nitrogen (LIN), in particular comprising a cooling coil in the liquefied natural gas vessel, would be a simpler and more favorable solution than for example an external supercooler. In this case, it must however be ensured that, no methane freezes on the cold surface of the refrigeration unit, the nitrogen content of the gas phase in the storage vessel does not rise in an uncontrol led manner and at the same time the pressure is kept below a maximum permissible pressure in the vessel. Moreover., for safety reasons, the nitrogen used for cooling must be completely vaporized after passage through the liquefied natural gas vessel, to prevent any emission of cryogenic liquids into the surrounding environment.

Against this background, the object of the present invention is therefore to provide a method and a refrigeration arrangement which are improved with regard to the above-stated problem.

This problem is solved by a method having the features of claim 1.

Advantageous embodiments of the method according to the invention are stated inter alia in the related subclaims.

According to claim 1, provision is made for the temperature of the substance mixture to be set such that the pressure in the first vessel is below a predefinabie value and the substance mixture is present in the liquid or gaseous phase at the set temperature and the pressure in the first vessel and in particular said substance mixture does not form a solid phase.

Pressure and temperature in the first vessel are thus selected such thats for example in the case of natural gas, all the constituents of the natural gas, i.e. in particular the methane, are gaseous or liquid. This is the case if pressure and temperature describe a state of the natural gas in the phase diagram which is above the “liquidus line”. Above the liquidus line, all components are in the liquid phase and below the “solidus line” all constituents of the natural gas are in the solid phase. At the liquidus line, in the case of LNG the methane in particular starts to freeze out and pass into the solid phase. The predefinable value, which does not exceed the pressure in the first vessel, is calculated in particular according to the type of vessel. In any event, however, this value is below the maximum pressure value for which the first vessel is designed and also above a pressure value at which ambient air may be drawn in, i.e. the first vessel is preferably kept above atmospheric pressure. Pressure values of such vessels vary in particular between 50 mbar and 16 bar overpressure, such that the predefined pressure value is within this range in accordance with the first vessel.

One variant of the invention provides for the substance mixture to comprise liquefied natural gas, wherein the first component is a hydrocarbon, in particular methane, and wherein the second component is in particular nitrogen. As already mentioned, if is possible for the substance mixture also to comprise further components, such as for example ethane, butane and/or propane, as well as heavier alkalies. One variant of the invention provides for the temperature to be set of the substance mixture to be determined by determining the mole fraction of the first component, in particular of methane.

in one preferred embodiment of the invention, the mole fraction of methane, in particular of the first component, of the substance mixture is determined from a pressure and temperature measurement in the first vessel, wherein, for the purpose of determining the mole fraction, the corresponding Coiling point of a nitrogen/methane substance mixture is in particular taken as basis for the pressure prevailing in the first vessel and the temperature prevailing in the first vessel. In other words, the methane content is determined on the basis in particular of the known profile of the boiling curve at various pressures of the substance mixture, wherein the substance mixture is here preferably assumed to be a pure methane/nitrogen mixture. By measuring pressure and temperature in the first vessel, it is thus possible to determine the mole fraction of methane in a temperature/mole fraction diagram for the corresponding pressure, since the measured temperature corresponds in particular to the boiling temperature of the substance mixture in the first vessel. It has been found that the methane mole fraction determined in this manner corresponds within small limits of error to the methane content of the substance mixture actually present, which in addition to methane and nitrogen may also comprise further substances (see above).

Pressure and temperature are preferably measured in the liquid phase of the substance mixture in the first vessel. This manner of determining the methane mole fraction in particular also works for substance mixtures which have further components in particular present in the LNG, such as for example ethane, since, at ethane concentrations typical of LNG, the profile of the boiling curve is substantially solely dependent on the nitrogen and methane content.

In one preferred variant of the invention, the temperature in the first vessel is regulated by way of an indirect heat, exchange with a refrigerant, wherein the refrigerant in particular contains nitrogen. The refrigerant is for example provided via an external, nitrogen reservoir, which contains liquid nitrogen.

In one embodiment of the invention, the refrigerant, is passed through the first vessel, wherein it flows in particular through a refrigerant line arranged in the first vessel (for example In the form of a cooling coil or other heat exchanger), and wherein before entry into the first vessel the refrigerant flow has a first temperature and a first pressure and after exit from the first vessel, has a second temperature and a second pressure. The second temperature and second pressure are preferably such that the refrigerant is present in the gaseous phase. Furthermore, the first temperature and first pressure are preferably such that the refrigerant is present at least in part in liquid phase.

The refrigerant, in particular nitrogen, absorbs neat from, the substance mixture, in particular the LNG, which results in a reduction in the pressure in the first vessel. Setting the first temperature and the first pressure of the refrigerant in particular fixes the boiling point of the refrigerant.

One variant of the invention furthermore provides for the first pressure and in particular the first temperature of the refrigerant flow in the first vessel so be set such that, the boiling temperature of the refrigerant at the pressure prevailing in the refrigerant line lies below the dew point of the substance mixture of the gas phase in the tank, and in particular below the boiling temperature below the liquid phase in the tank, and wherein the boiling temperature of the refrigerant lies above the liquidus temperature of the substance mixture in the tank.

It is known that the boiling point of a liquid in particular depends on the pressure. Setting a suitable pressure sets the boiling point and thus the vaporisation temperature of the refrigerant (the term boiling curve is used in a phase diagram). It is thus for example wholly possible that, as a result of the different pressure in the first vessel and in the refrigerant line and/or heat exchanger, in particular the nitrogen used as refrigerant has a different boiling temperature than for example the substance mixture in the first vessel. The pressure and/or the mass flow rate of the refrigerant is in particular set such that the refrigerant is present in gaseous phase after flowing through the first vessel (and the associated heat absorption). It is moreover ensured in this way that the temperature of the refrigerant is not so high that no condensation of the gaseous phase of the substance mixture would take place in the first vessel. Furthermore, the temperature of the refrigerant, is not set so low that a component, in particular the methane, would pass into the solid phase at the pressure conditions and mixture composition prevailing in the first vessel, i.e. would freeze on the refrigerant line, which would lead to a reduction in heat transfer to the refrigerant, since methane ice in particular is a comparatively good thermal insulator.

One variant of the invention provides for a first valve, which is arranged in particular upstream of the first vessel, to regulate refrigerant flow, wherein the refrigerant, flow is increased if the pressure in the first vessel exceeds a predefined value and wherein the refrigerant flow is reduced if the refrigerant is not completely present in the gaseous phase after flowing through the first vessel or the pressure in the first vessel fails below a predefined value. The emission in particular of cryogenic liquids at the end of refrigeration for example into the open surrounding environment is thus avoided.

In a preferred variant of the invention, a second valve, which is arranged in particular downstream of the first vessel, is provided, which in particular regulates the pressure and the temperature of the

The problem according to the invention is additionally solved by a refrigeration arrangement according to claim 11.

Such a refrigeration arrangement for regulating the pressure in a first vessel for a substance mixture, in particular for liquefied gas, in particular for liquefied natural gas, in this case comprises the following features:
a refrigerant reservoir, from which a refrigerant line is guided in a refrigerant-conveying manner through the first vessel,
a first valve for regulating refrigerant flow in the refrigerant line, which is arranged upstream of the first vessel,
a second valve for regulating the pressure and temperature of the refrigerant flow, which is arranged downstream of the first vessel in the refrigerant line, and
a pressure gauge and a temperature gauge, which are configured to measure the pressure and temperature in the first vessel.

The temperature gauge is here configured such that a temperature measurement is preferably made at a point of the first vessel which is below the filling level in the first vessel.

In one preferred embodiment of the invention, when the vessel is filled with the substance mixture, the refrigerant line extends at least in part above the level of the substance mixture in the first vessel.

In one preferred embodiment of the invention, a second vessel, which configured to accommodate the substance mixture, is connected to the first vessel at least thermally conductively, wherein in particular the gaseous and/or the liquid phase of the substance mixture may flow to-and-fro between the first and the second vessel,

Regulation of pressure and temperature is here also possible for the second vessel, although no refrigerant line is passed through the second vessel, since at least thermal exchange is ensured between the first and second vessels.

The following descriptions of figures of exemplary embodiments of the invention explain further features and advantages of the invention with reference to the figures, in which:

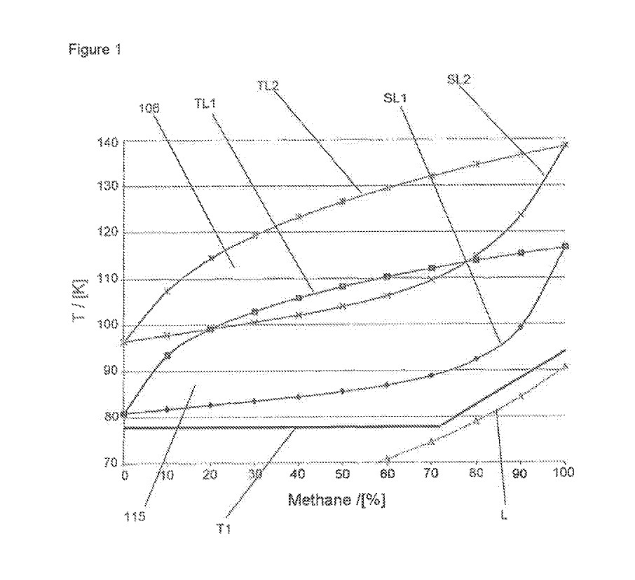

FIG. 1 shows a phase diagram of a methane/nitrogen mixture for two different pressures;

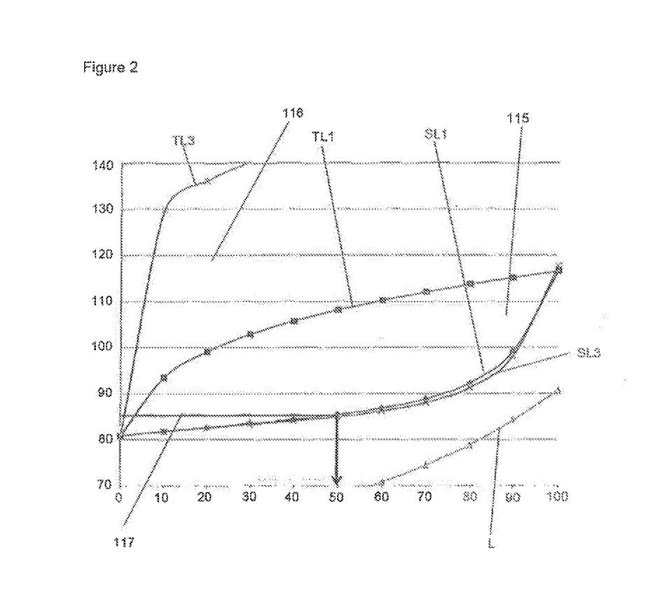

FIG. 2 snows a phase diagram of a methane/nitrogen mixture and a methane/nitrogen/ethane mixture with a 7% ethane mole fraction;

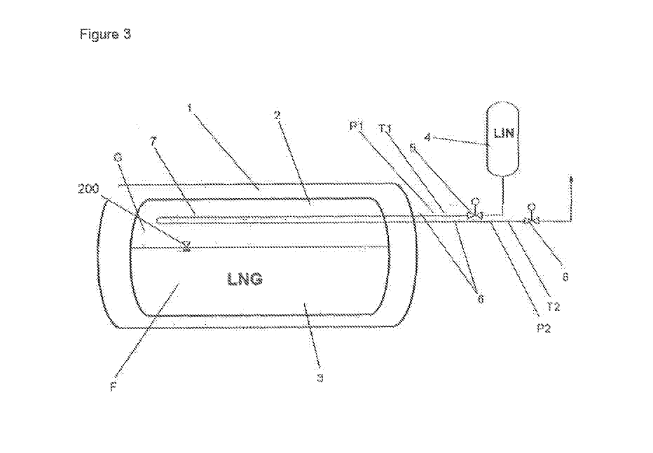

FIG. 3 is a schematic representation of a refrigeration arrangement according to the invent ion;

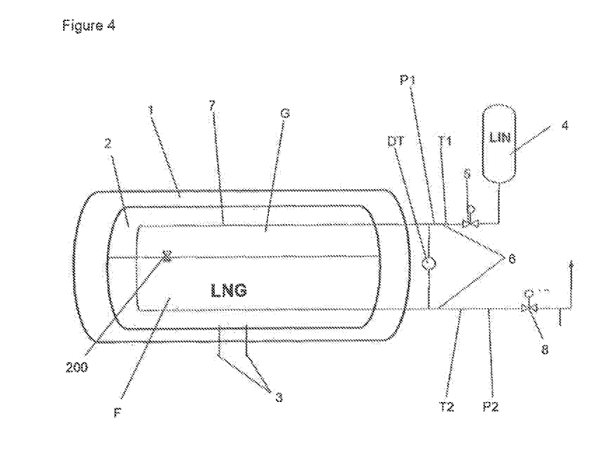

FIG. 4 is a schematic representation of a further refrigeration arrangement according to the invention; and

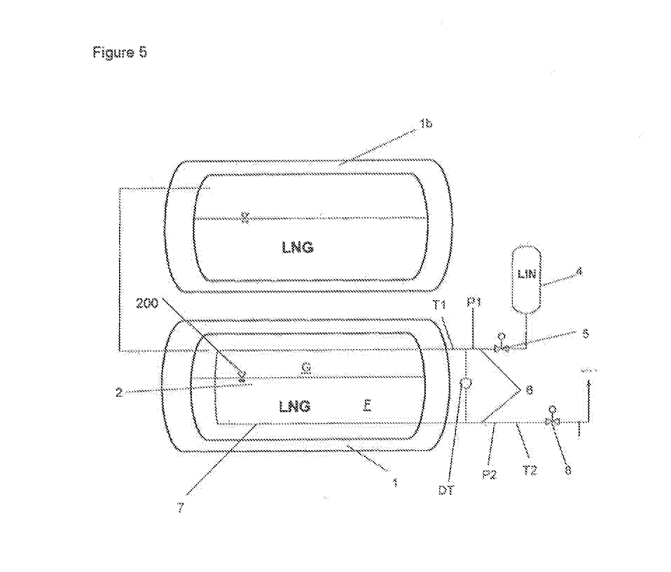

FIG. 5 is a schematic representation of a refrigeration arrangement according to the invention with two vessels.

FIG. 1 shows a phase diagram 106, 115 for a substance mixture in the form of a methane/nitrogen mixture at a pressure of 1.5 bar(a) 115 and a pressure of 6(a) bar 106. The boiling curves SL1 (1.5 bar) and SL2 (6 bar) respectively and the dew-point or condensation curves TL1 (1.5 bar) and TL2 (6 bar) respectively are plotted. Furthermore, the liquidus line L is plotted. It is apparent from the phase diagram that the liquidus temperature depends strongly on the methane content (x axis) of the substance mixture and likewise fails as the methane content falls.

Furthermore, in the selected example there is always a temperature difference of at least 15 K between the liquidus line L and the boiling curve SL1.

The temperature of a refrigerant is then adjusted precisely such that a first temperature T1 of the refrigerant extends below the boiling curve SL1, SL2 depending on the methane-mole fraction of the methane/nitrogen mixture, but above the Iiquidus line L. This is comparatively easy to achieve given said temperature difference between the liquidus line L and the boiling curve SL1 (for example, the first temperature may be set 10 K below the boiling curve SL1). In this way, it is ensured that the methane does not freeze out and at the same time the first temperature T1 of the refrigerant is sufficiently low to refrigerate the substance mixture, such that the fractions of the gaseous phase G are converted into the liquid phase F, provided that the pressure in the first vessel 1 has reached a guide value.

It is then possible, for example, to interrupt refrigeration and only to continue it when the pressure in the first vessel 1 has reached a predefined pressure value, from which refrigeration down to the guide value is then performed again.

It is thus apparent from FIG. 1 what first temperature the refrigerant must have as a function of the liquidus line L and the respective boiling curve SL1/SL2, for regulation of the temperature and of the pressure in the first vessel 1 to proceed according to the invention.

FIG. 2 depicts two phase diagrams 115, 116, wherein the first phase diagram 115 corresponds to a pure methane/nitrogen mixture (see also FIG. 1), b further phase diagram 116 (likewise drawn up for a pressure of 1.5 bar) shows the profile of the boiling curve SL3 and of the condensation curve TL3 if 7% ethane is additionally admixed to the methane/nitrogen mixture. It can be seen that the boiling curves SL1 and SL3 differ only marginally from one another. It may be concluded from this that the methane content of the two substance mixtures in the liquid phase may be approximately determined by way of a temperature and pressure measurement in the first vessel 1. Thus, for example, a substance mixture which is in the first vessel 1 under a pressure of 1.5 bar and at a temperature of for example 85 K 117 has a methane content (or indeed molar fraction) of 50%, virtually irrespective of the ethane content of the substance mixture. By way of such a determination of the methane content, the first temperature T1 of the refrigerant with which the substance mixture may be cooled may then be determined. It should be noted that a boiling curve for a methane/nitrogen mixture for typical concentrations of other components arising in LNG, such as ethane, butane, propane etc., varies only slightly. However, as soon as the concentrations of the other components deviate to an appreciable extent from the conventional composition of LNG, completely different boiling curve profiles may also result.

It is apparent from FIG. 2 that even a pure nitrogen gas phase (methane content 0%; may be condensed on cooling. If only nitrogen is stored in the first vessel. 1, liquid nitrogen for example used as a refrigerant at 77 K with a carpet temperature of 87 k may produce a nitrogen gas phase of 87 K in the first vessel 1 and a corresponding pressure of 2.7 bar in the first vessel 1.

FIG. 3 shows a refrigeration arrangement according to the invention, comprising a first vessel 1 which is configured, to accommodate the substance mixture, in particular LNG. The first vessel 1 preferably comprises thermal insulation., which thermally insulates the substance mixture from the ambient heat. The substance mixture may be scored in the interior 2 of the first vessel 1. A temperature and pressure gauge 3, with which the temperature and pressure may be determined preferably in the liquid phase F of the substance mixture, is also located therein. An external liquid nitrogen reservoir 4 is connected via a first valve 5 to the first vessel 1 via a refrigerant line 6. The first valve 5 serves in particular to regulate refrigerant flow in the refrigerant line 6. The liquid nitrogen is passed through the first vessel 1 in the refrigerant line 6, which in particular may take the form of a cooling coil 7 at least in places, at a first pressure P1 and at a first temperature T1, wherein in particular the first temperature T1 rises to a second temperature T2 on passage through the cooling coil 7. The refrigerant is then drawn off again at the second temperature T2 from the first vessel 1, wherein a second valve 8 is arranged in the refrigerant line 6 with which in particular the first pressure P1 and the first temperature T1 may be set. In this exemplary embodiment, the refrigerant line 6 or the cooling coil 7 extends in the first vessel 1 completely in the gaseous phase G of the substance mixture.

In FIG. 4, in contrast, the portion of the refrigerant line 6 or the cooling coil 7 located in the first vessel extends both in the gaseous phase G and in the liquid phase F of the substance mixture. This arrangement of the cooling coil 7 better ensures that the refrigerant passes completely into the gaseous phase by passage through the liquid phase F of the substance mixture and thus is already present wholly in the gaseous phase at the second valve 8, so preventing emission of cryogenic liquids.

Furthermore, in the exemplary embodiment according to FIG. 4, a temperature difference meter DT may be provided, which measures the difference between the first temperature T1 (inlet temperature) and the second temperature (outlet temperature). On the basis of this difference, a conclusion may be drawn as to the state of the refrigerant at the second valve 8. Alternatively, the second pressure P2 and the second temperature T2 may be measured upstream of the second valve 8, whereby the state of the refrigerant, may likewise be determined.

In a third variant, it is ensured that the refrigerant is already boiling at the first temperature T1 and the first pressure P1. The first valve 5 then regulates the refrigerant flow on the one hand such that it ensures sufficient cooling of the substance mixture and on the other hand such that the refrigerant is present in gaseous form, at the second valve 8. Control of the first and second valves 5, 8 may proceed for example via a PID control system, wherein presence of the refrigerant wholly in the gaseous phase would, serve as a limiter.

FIG. 5 shows a further exemplary embodiment in which a second vessel 1b is connected, to the first vessel 1, wherein regulation of the pressure and temperature takes place only in the first vessel 1 and also has an impact on the second vessel 1b as a result of thermal transfer.

LIST OF REFERENCE NUMERALS

| | |
|---|---|
| 1 | First vessel |
| 1b | Second vessel |
| 2 | Interior of first vessel |
| 3 | Temperature and pressure gauge |
| 4 | Refrigerant reservoir |
| 5 | First valve |
| 6 | Refrigerant line |
| 7 | Cooling coil |
| 8 | Second valve |
| 106 | Methane/nitrogen mixture at 6 bar |
| 115 | Methane/nitrogen mixture at 1.5 bar |
| 116 | Methane/nitrogen/ethane mixture at 1.5 bar |
| 117 | Measured temperature |
| 200 | Refrigerant level |
| DT | Differential temperature gauge |
| L | Liquidus line |
| P1 | First pressure |
| P2 | Second pressure |
| SL1 | Boiling curve of methane/nitrogen mixture at |
| | 1.5 bar |
| SL2 | Boiling curve of methane/nitrogen mixture at |
| | 6 bar |
| SL3 | Boiling curve of methane/nitrogen/ethane |
| | mixture at 1.5 bar |
| T1 | First temperature |
| T2 | Second temperature |
| TL1 | Condensation curve/dew-point curve of |
| | methane/nitrogen mixture at 1.5 bar |
| TL2 | Condensation curve/dew-point curve of |
| | methane/nitrogen mixture at 6 bar |
| TL3 | Condensation curve/dew-point curve of |
| | methane/nitrogen/ethane mixture at 1.5 bar |

1. A method for regulating the pressure in a first vessel, comprising a substance mixture present in liquid and gaseous phase, which comprises a first component and a second component, characterized in that the temperature of the substance mixture is set such that the pressure in the first vessel is below a predefinabie value and the substance mixture at the set temperature and the prevailing pressure in the first vessel is present only in the liquid and the gaseous phase.

2. The method as claimed in claim 1, characterized in that the substance mixture comprises liquefied natural gas, wherein the first component is a hydrocarbon and wherein the second component is in particular nitrogen.

3. The method as claimed in claim 1, characterized in that, to determine the mole fraction of the first component, a pressure and temperature measurement of the substance mixture is carried out, and wherein the mole fraction is determined by means of the boiling curve associated with the pressure.

4. The method as claimed in claim 3, characterized in that the temperature of the substance mixture lies between the temperature, associated with the determined mole fraction of the first component, of the liquidus line of the substance mixture and the temperature, associated with the determined mole fraction, of the dew-point curve of the substance mixture or of the boiling curve of the substance mixture.

5. The method as claimed in claim 1, characterized in that the temperature in the first vessel is set by indirect heat exchange between the substance mixture and a refrigerant.

6. The method as claimed in claim 1, characterized in that the refrigerant is passed through the first vessel in the form of a refrigerant flow, wherein before entry into the first vessel the refrigerant flow has a first temperature and a first pressure and after exit from the first vessel has a second temperature and a second pressure, and wherein the second temperature and the second pressure are such that the refrigerant flow is present in the gaseous phase, and wherein the first temperature and the first pressure are in particular such that the refrigerant flow is present at least in part in the liquid phase.

7. The method as claimed in claim 6, characterized in that the first pressure of the refrigerant flow in the first vessel is set such that the boiling temperature of the refrigerant lies below the boiling temperature of the substance mixture and wherein the boiling temperature of the refrigerant lies at or above the Iiquidus temperature of the substance mixture.

8. The method as claimed in claim 6, characterized in that the first temperature of the refrigerant flow lies between the temperature, associated with the determined mole fraction of the first component, of the liquidus line of the substance mixture and the temperature, associated with the determined mole fraction, of the boiling curve of the substance mixture.

9. The method as claimed in claim 1, characterized in that, by means of a first valve, which is arranged in particular upstream of the first vessel, refrigerant flow is regulated, wherein the refrigerant flow is increased if the pressure in the first vessel exceeds a predefined value and wherein the refrigerant flow is reduced if the refrigerant is not completely present in the gaseous phase after flowing through the first vessel.

10. The method as claimed in claim 1, characterized in that, by means of a second valve, which is arranged in particular downstream of the first vessel, the pressure and the temperature of the refrigerant flow are regulated, wherein the pressure of the boiling refrigerant flow is set such that the boiling temperature thereof lies above the liquidus line and below the boiling curve of the substance mixture in the determined composition of the substance mixture or in the determined mole fraction of the first component of the substance mixture.

11. A refrigeration arrangement for regulating the pressure in a first vessel for a substance mixture comprising:
a refrigerant reservoir, from which a refrigerant line is guided through the first vessel,
a first valve for regulating a refrigerant flow guided in the refrigerant line, wherein the first valve is arranged upstream of the first vessel,
a second valve for regulating the pressure and temperature of a refrigerant flow guided in the refrigerant line, wherein the second valve is arranged downstream of the first vessel,
a pressure gauge and a temperature gauge for measuring the pressure and temperature of the substance mixture in the first vessel.

12. The refrigeration arrangement as claimed in claim 11, characterized in that, when the vessel is filled with the substance mixture, the refrigerant line is configured to extend at least in part above the level of the substance mixture in the first vessel.

13. The refrigeration arrangement as claimed in claim 11, characterized in that a second vessel, which is likewise configured to accommodate the substance mixture, is connected to the first vessel (4) at least thermally conductively, wherein in particular the two vessels are connected such that the gaseous and/or the liquid phase of the substance mixture may flow to-and-fro between the two vessels.

14. The method as claimed in claim 2 characterized in that the hydrocarbon is methane.

15. The method as claimed in claim 3, characterized in that the first component is methane.

16. The method as claimed in claim 3, characterized in that the boiling curve of a nitrogen/methane substance mixture is used as basis.

17. The method as claimed in claim 5, characterized in that the refrigerant comprises nitrogen or is formed by nitrogen.

18. The method as claimed in claim 7, characterized in that the boiling temperature is selected from the group consisting of below the natural gas boiling point and below the nitrogen boiling point.

19. The refrigeration arrangement as claimed in claim 11, characterized in that the substance mixture is selected from the group consisting of liquefied gas and liquefied natural gas.
